(19) United States
(12) Patent Application Publication
(10) Pub. No.: US 2009/0158210 A1
(43) Pub. Date: Jun. 18, 2009

(54) Automatically reflecting offline state and objects in a virtual representation

(76) Inventors: Grace Shih Chun Cheng, Mountain View, CA (US); Neil Geoffrey Smith, Mountain View, CA (US)

Correspondence Address: NEIL SMITH, 928 WRIGHT AVENUE APT 804, MOUNTAIN VIEW, CA, 94043, US

(21) Appl. No.: 12/316,879

(22) Filed: Dec. 16, 2008

Related U.S. Application Data
(60) Provisional application No. 61/008,004, filed on Dec. 17, 2007.

(51) Int. Cl. G06F 3/048; G06Q 30/00; G06T 11/00; G08B 7/06

(52) U.S. Cl. 715/810; 705/14; 345/522; 340/572.1

(57) ABSTRACT

A method for automatically representing offline state and objects in a virtual representation. A user of this method can interact with objects in the real world in a natural way and automatically have a virtual representation of those objects updated. For example, a user may have a real toy with a virtual representation. When the user dresses the real toy with real clothes the virtual representation of the toy will automatically reflect the clothing and accessories placed on the toy. Similarly, when the user dresses in suitably adapted clothing, their own virtual representation will be automatically updated to reflect that clothing. Thus an automatic and seamless method is provided to have virtual representations of objects reflect their state in the real world.

### CROSS-REFERENCE TO RELATED APPLICATIONS

This application claims the benefit of provisional patent application Ser. No. 61/008,004, filed 2007 Dec. 17 by the present inventors.

### FEDERALLY SPONSORED RESEARCH

Not Applicable

### SEQUENCE LISTING OR PROGRAM

Not Applicable

### BACKGROUND OF THE INVENTION

1. Field of Invention

This invention generally relates to toys and play, specifically to the virtual representation of real toys and other play things.

2. Prior Art

Toys exist in either the real world where they are played with physically or the virtual world inside a computer system where they are played with via a computer interface. This separation denies the real world toy much of the flexibility and functionality that can be represented in a virtual toy, and denies the virtual toy the natural physical interaction that the owner enjoys with a real toy.

Similarly a person will dress themselves in the real world and then may use a traditional computer interface to dress their online representation (“avatar”), or they may type a special sequence of characters to reflect their current real world state of mind or emotions (“emoticons”). Within a computer game a player may accumulate objects that empower their virtual representation with special abilities but the connection to real world objects does not exist.

For centuries toys have been manufactured with clothing and accessories. The owner enjoys the process of dressing and accessorizing the toy. Build-A-Bear Workshop of Saint Louis, Mo. has an extensive retail chain where an assortment of plush along with clothing and accessories suitable for those plush can be purchased.

More recently virtual toys have been created that also allow the owner of the virtual toy to dress their virtual toy in virtual clothing. Club Penguin of Kelowna, British Columbia has created such an online environment.

For users who wish to represent themselves online, Yahoo! Avatars offers a broad range of clothing, styles and accessories that a user can choose to dress their avatar through an interface on the World Wide Web. These avatars can also be assigned emotions through a selection on screen or through typing a special sequence of characters.

It is commonplace within computer games that the character that the player controls will collect objects within the virtual world. These objects will empower the character with additional abilities.

In each of these situations there is a very clear distinction between the state and characteristics of objects in the real world and their representation in the virtual world. Reflecting the real world state into the virtual world requires manual configuration through a computer interface thereby reducing the fluidity of play along with the enjoyment and engagement felt by the user.

Insofar as we are aware, for the use cases described above, no mechanism formerly developed provides the means to have an object's state, clothing and accessories in the real world automatically represented in a virtual or online world.

### SUMMARY

In accordance with one embodiment, a means to automatically detect an object's offline state and the other objects that may be around it, to automatically communicate such state and object information to an online system such that the state and objects may be reflected in virtual representations without further interaction from the user.

### DRAWINGS

### Figures

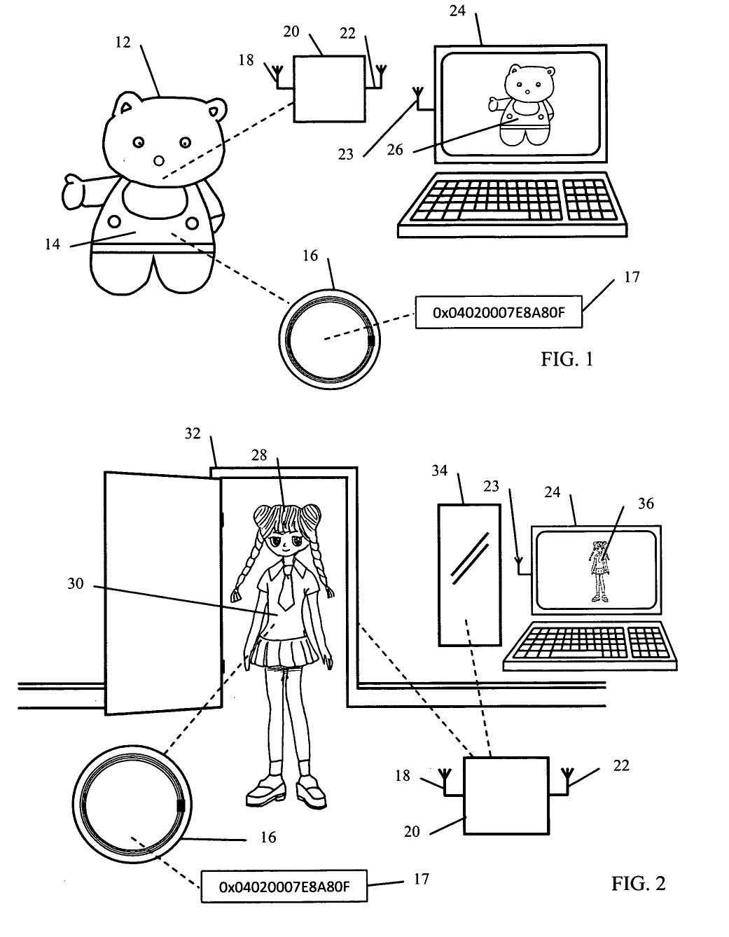

FIG. 1 is a representation of the dressed toy in the real world, a potential embodiment of a means to detect the clothing, accessories and other objects associated with said toy, a potential embodiment of a means to transmit data with respect to said clothing, accessories and other objects to a potential embodiment of a computer system and a potential embodiment of the virtual reflection of said toy and associated objects on said computer system.

FIG. 2 is a representation of the dressed child in the real world, a potential embodiment of a means to detect the clothing, accessories and other objects associated with said child, a potential embodiment of a means to transmit data with respect to said clothing, accessories and other objects to a potential embodiment of a computer system and a potential embodiment of the virtual reflection of said child and associated objects on said computer system.

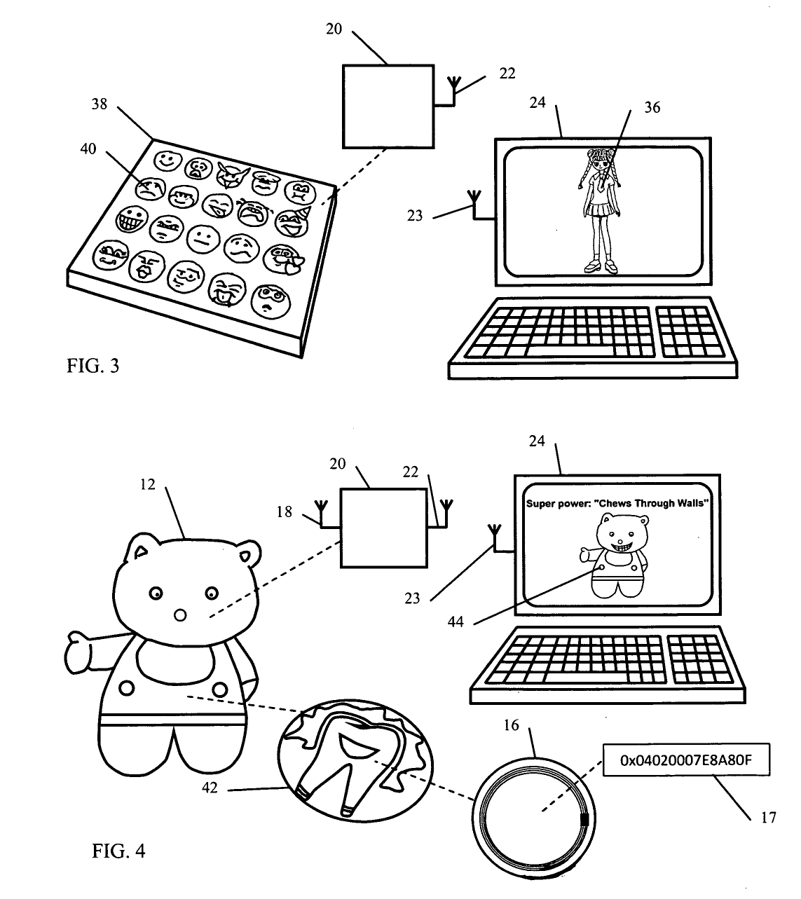

FIG. 3 is a representation of a potential embodiment of the emotion indicator board, a potential embodiment of a means to transmit data indicating the selected emotion to a potential embodiment of a computer system and a potential embodiment of the virtual reflection of said selected emotion on said computer system.

FIG. 4 is a representation of a potential embodiment of a reward object in the real world, in this case a tooth reward pin/badge given by a dentist, a potential embodiment of a means to detect the presence of said reward object, a potential embodiment of a means to transmit data with respect to said reward object to a potential embodiment of a computer system and a potential embodiment of the virtual reflection of said reward object.

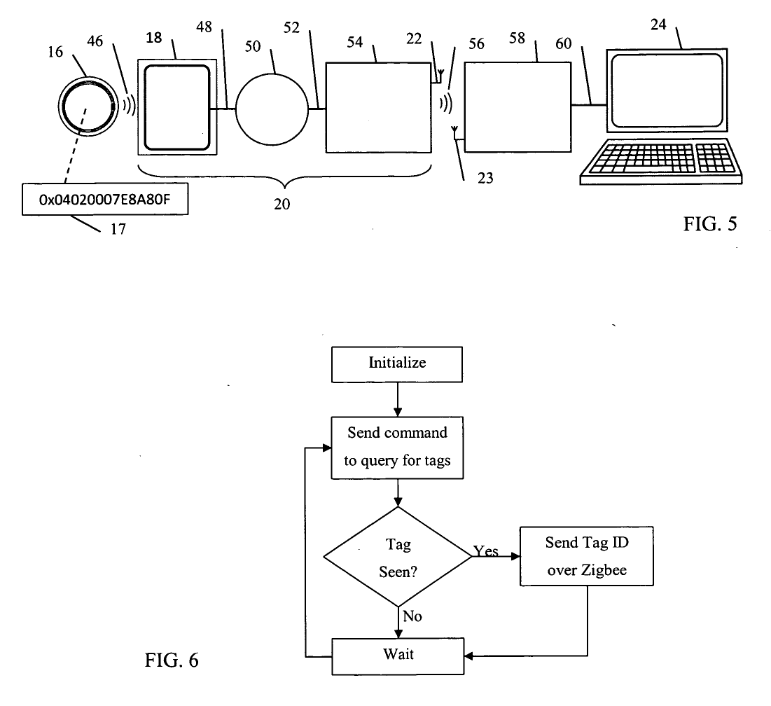

FIG. 5 is a representation of a potential embodiment of the invention including RFID technology as a means of object detection and identification and a Zigbee network as a means of transmitting the state and presence of objects to the computer system representing the virtual world.

FIG. 6 is a flowchart representing a program that could be run in the detector in the potential embodiment of the invention including RFID technology as a means of object detection and identification.

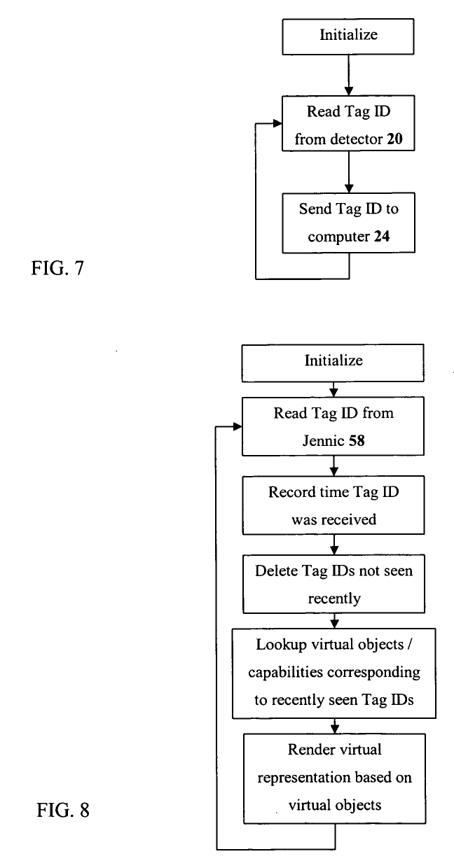

FIG. 7 is a flowchart representing a program that could be run in the wireless receiver in the potential embodiment of the invention including Zigbee wireless connectivity to connect the detector to the computer.

FIG. 8 is a flowchart representing a potential embodiment of a program that could be run in the computer system to receive information with respect to the objects seen and use that information to render the virtual representation.

### DRAWINGS

### Reference Numerals

12 plush
14 plush clothing
16 RFID tag
17 RFID identifier code
18 RFID antenna (detector)
20 detector
22 Zigbee antenna (detector)
23 Zigbee antenna (computer system)
24 computer system with additional capability
26 virtual representation of plush
28 user
30 user clothing
32 doorway
34 mirror
36 virtual representation of user
38 emotion selector
40 emotion representation
42 reward pin/badge
44 virtual representation of plush
46 RFID electromagnetic field
48 twisted pair connection 56 Zigbee connection
50 Skyetek M1-mini RFID reader 58 Jennic 5139 evaluation board
52 TTL connection 60 TTL connection
54 Jennic 5139 evaluation board

### DETAILED DESCRIPTION

### FIGS. 1-8

FIG. 1 represents a potential embodiment of the invention. A plush 12 is dressed in items of clothing 14. Each item of clothing 14 has an associated RFID tag 16. Each RFID tag has an associated RFID identifier code 17. Embedded within the plush 12 is a detector 20. Through RFID antenna 18 the detector 20 detects the RFID tags 16 and transmits data indicating the presence of each RFID tag 16 to a computer system 24 via Zigbee antenna 22. Receiving said data via Zigbee antenna 23, the computer system 24 renders a representation of the plush 26 with each of the items of clothing 14. Should an item of clothing 14 be removed from the plush 12 then the detector 20 will similarly transmit this fact to the computer system 24 and the representation of the plush 26 will change automatically. Should an item of clothing 14 be added to the plush 12 the detector will transmit this fact to the computer system 24 and the representation of the plush 26 will change automatically.

FIG. 2 represents a potential embodiment of the invention. A user 28 is dressed in items of clothing 30. Each item of clothing 30 has an associated RFID tag 16. Each RFID tag has an associated RFID identifier code 17. When the RFID tags 16 worn by the user 28, pass within range of the RFID antenna 18 attached to a detector 20, which may, for example, be embedded in a doorway 32 or mirror 34, the detector 20 will detect the presence of the RFID tags 16 and via Zigbee antenna 22 transmit data indicating their presence to a computer system 24 such that a virtual representation of the user 36 may reflect the user clothing 30.

FIG. 3 represents a potential embodiment of the invention. An emotion selector 38 is provided as a means to select an emotion by indicating one of the emotion representations 40. Examples of means to make such a selection may be through an electronic push-button, a magnetic proximity switch or a voice recognition mechanism built into the emotion selector 38. The emotion selector 38 includes a detector 20 which will transmit via Zigbee antenna 22 data representing the selected emotion representation 40 to a computer system 24. The computer system 24 will update a virtual representation of the user 36 based on the emotion selected.

FIG. 4 represents a potential embodiment of the invention. Suppose that a user has been rewarded for visiting a dentist and has received a reward pin/badge 42 which includes an RFID tag 16 with an embedded RFID identifier code 17. When the reward pin/badge 42 is placed on a plush 12 a detector 20 will, via RFID antenna 18, detect the presence of the reward pin/badge 42 and transmit data indicating that fact to a computer system 24. The computer system 24 will automatically update to reflect a virtual representation of the plush with additional capability 44 corresponding to that reward pin/badge 42.

FIG. 5 represents a schematic of the potential embodiment prototype constructed by the inventors. A detector 20 includes RFID antenna 18 connected via a twisted pair connection 48 to a Skyetek M1-mini RFID reader 50 in turn connected via TTL connection 52 to a Jennic 5139 evaluation board 54. Detector 20 detects the presence of RFID tag 16 and transmits via Zigbee antenna 22 data related to the RFID identifier code 17 over Zigbee connection 56 to Jennic 5139 evaluation board 58 in turn connected via TTL connection 60 to computer system 24.

Present prototypes make use of the Skyetek M1-mini RFID reader and Jennic 5139 microprocessor but other devices are suitable and within the scope of the invention An alternative embodiment would see RFID reader 50 connected directly over TTL connection 52 to computer system 24. This would reduce the component count and cost but result in a wired solution that would not enable wireless motion of the detector 20. One potential embodiment of the computer system 24 comprises a single computer running software sufficient to render the virtual representation. An alternative embodiment of the computer system 24 comprises the entire Internet where any particular computer connected to the Internet could receive data representing information to be reflected into the applicable virtual representation.

FIG. 6 represents one potential flow of control in the program running on a Jennic 5139 evaluation board 54 in detector 20 as used in the potential embodiment described above and represented in FIG. 5. Following initialization of the systems, Jennic 5139 evaluation board 54 sends a command to query for RFID tags 16 over TTL connection 52 to Skyetek M1-mini RFID reader 50. Should said RFID reader detect the presence of RFID tag 16 then the program will send data representing the RFID identifier code 17 over Zigbee connection 56 ultimately to the computer system 24. If no RFID tag 16 is detected then the program waits and queries said RFID reader again after a suitable period. Naturally many more sophisticated flows could be used in alternative embodiments within the scope of the invention. For example, the wait time between queries to the RFID reader could be adjusted dynamically to respond more quickly when the toy is being played with or at night. Doing so could make the toy responsive and save battery life in a battery operated toy.

FIG. 7 represents one potential flow of control in the program running on a Jennic 5139 evaluation board 58 as used in the potential embodiment described above and represented in FIG. 5.

Following initialization of the system, Jennic 5139 evaluation board 58 receives data corresponding to RFID identifier codes 17 corresponding to RFID Tags 16 detected by detector 20 and transmitted over Zigbee connection 56. Each RFID identifier code 17 received is then transmitted to computer system 24 over TTL connection 60.

FIG. 8 represents one potential flow of control in the program running on computer system 24 as used in the potential embodiment described above and represented in FIG. 5. Following initialization of the system, computer system 24 waits to receive data corresponding to RFID identifier code 17 over TTL connection 60. Computer system 24 determines which RFID identifier codes 17 have not been detected within a predetermined time. RFID identifier codes 17 that have not been seen are deleted from memory. Computer system 24 uses the RFID identifier codes 17 corresponding to individual RFID tags 16 to determine the corresponding virtual object representations that are then combined in order to render the virtual representation.

### OPERATION

### FIGS. 1-8

In operating the potential embodiment represented in FIG. 1 a user plays with plush 12 normally. Dressing and undressing plush 12 with plush clothing 14 seamlessly results in a virtual representation of plush 26 reflecting the corresponding presence or absence of plush clothing 14.

In operating the potential embodiment represented in FIG. 2 a user 28 dresses normally with user clothing 30. When dressed as desired user 28 approaches detector 20, which may, for example, be located within doorway 32 or mirror 34. Detector 20 automatically detects RFID tags 16 in user clothing 30 and transmits the appropriate information to a computer system 24 so that a virtual representation of user 32 can be updated based on the presence of user clothing 30.

In operating the potential embodiment represented in FIG. 3 a user simply indicates their emotional state through selecting the appropriate emotional representation 40 on emotion selector 38. Possible ways to make this selection could include mechanical push-buttons, capacitive sensors, magnetic switches etc. A detector 20 associated with emotion selector 38 transmits the user's selection to a computer system 24 and a virtual representation of user 36 is updated as appropriate.

In operating the potential embodiment represented in FIG. 4 a user would receive a reward pin/badge 42 with embedded RFID tag 16. On attaching the reward pin/badge 42 to a plush 12, a detector 20 would automatically detect the RFID Tag 16 and transmit the corresponding RFID identifier code 17 ultimately to a computer system 24 so that the computer system 24 may render a virtual representation of plush with additional capability 44.

### CONCLUSION, RAMIFICATIONS, AND SCOPE

Accordingly the reader will see that, according to one embodiment of the invention, I have provided means to reflect the state of offline objects and changes thereto in a virtual representation.

While the above description contains many specificities, these should not be construed as limitations on the scope of any embodiment, but as exemplifications of the presently preferred embodiments thereof. Many other ramifications and variations are possible within the teachings of the various embodiments. Thus the scope of the inventions should be determined by the appended claims and their legal equivalents, and not by the examples given.

1. A method of automatically representing offline objects in a virtual representation, comprising:
(a) a plurality of offline objects,
(b) a means for detecting said offline objects,
(c) a means for transmitting data representing said offline objects to a computer system, and
(d) a virtual representation of said offline objects rendered by said computer system,
whereby, when said offline objects may be automatically detected by said detection means, said representative data is automatically transmitted over said transmission means to said computer system to enable rendering of said virtual representation without requiring additional action.

2. The method of claim 1 wherein said offline objects are toys, clothing or accessories.

3. The method of claim 1 wherein said means for detecting said offline objects comprises (a) a means to tag each offline object with an identifier and (b) a means to detect said tags, whereby said computer system may benefit from said identifier in said tag to determine the corresponding virtual representation for each tag so detected.

4. The method of claim 3 wherein said tag and said means to detect said tags make use of RFID technology.

5. The method of claim 4 wherein said means to detect said tags is encapsulated within a doorway or mirror.

6. The method of claim 1 wherein said means for transmitting said data comprises a wireless communication channel whereby said computer system may be physically separated from said means for detecting said offline objects.

7. The method of claim 1 wherein said virtual representation is for recreational or learning purposes and said virtual representation includes a realistic graphical representation of said offline objects.

8. The method of claim 1 wherein said virtual representation is rendered within a game or Web browser.

9. The method of claim 1 wherein said offline objects are toys, clothing or accessories, and wherein said means for detecting said offline objects comprises (a) an RFID tag corresponding to each offline object to be detected and (b) an RFID tag reader to detect said RFID tags, and wherein said means for transmitting said data comprises a wireless communication channel whereby said computer system may be physically separated from said means for detecting said offline objects, and wherein said virtual representation is (a) for recreational or learning purposes, (b) includes a realistic graphical representation of said offline objects and (c) is rendered within a game or Web browser.

10. The method of claim 1 wherein said offline objects are clothing or accessories, and wherein said means for detecting said offline objects comprises (a) an RFID tag corresponding to each offline object to be detected and (b) an RFID tag reader to detect said RFID tags, and wherein said RFID tag reader is encapsulated within a mirror, and wherein said means for transmitting said data comprises a wireless communication channel whereby said computer system may be physically separated from said means for detecting said offline objects, and wherein said virtual representation is (a) for recreational or learning purposes, (b) includes a realistic graphical representation of said offline objects and (c) is rendered within a game or Web browser.

11. A method of incentivizing a person to carry out a specific action comprising:
(a) providing an offline object to said person on completion of said specific action,
(b) a means for automatically detecting said offline object,
(c) a means for transmitting data representing said offline object to a computer system, and
(d) a means for providing a reward in a virtual environment
whereby, when said offline object may be detected by said detection means, said representative data is automatically transmitted over said transmission means to said computer system to trigger delivery of said reward to said person.

12. The method of claim 11 wherein said means for detecting said offline object comprises (a) an RFID tag corresponding to said offline object to be detected and (b) an RFID reader to detect said RFID tags.

13. The method of claim 11 wherein said virtual environment and is for recreational or learning purposes.

14. The method of claim 13 wherein said virtual environment is rendered within a game or Web browser.

15. The method of claim 11 wherein said means for detecting said offline object comprises (a) an RFID tag corresponding to said offline object to be detected and (b) an RFID reader to detect said RFID tags, and wherein said means for transmitting said data comprises a wireless communication channel, and wherein said reward is provided within a virtual environment and is for recreational or learning purposes, and wherein said virtual environment is rendered within a game or Web browser.

16. A method of indicating an emotional state to a computer system, comprising:
(a) a means for selecting from a range of emotional states,
(b) a means to allow the user to make a specific selection from said range of emotional states, and
(c) a means for transmitting data representing said selection to said computer system,
whereby, when said user makes said selection from said emotional states said representative data is automatically transmitted over said transmission means to said computer system.

17. The method of claim 16 wherein said means for selection comprises a physical device visually representing a predetermined range of emotional states.

18. The method of claim 16 wherein said means for selection comprises a physical device visually representing a predetermined range of emotional states, and wherein said means for transmitting said representative data to said computer system comprises a wireless communication channel.
